(19) United States
(12) Patent Application Publication
(10) Pub. No.: US 2018/0135718 A1
(43) Pub. Date: May 17, 2018

(54) SHOCK ABSORBER

(71) Applicant: KYB Corporation, Tokyo (JP)

(72) Inventors: Yasunori KOBAYASHI, Tokyo (JP); Takao MURATA, Tokyo (JP)

(73) Assignee: KYB Corporation, Tokyo (JP)

(21) Appl. No.: 15/572,394

(22) PCT Filed: Jun. 8, 2016
(86) PCT No.: PCT/JP2016/067056

§ 371 Date: Nov. 7, 2017

(30) Foreign Application Priority Data
Jul. 23, 2015 (JP) 2015-145421

(51) Int. Cl. F16F 9/32

(52) U.S. Cl. CPC F16F 9/32

(57) ABSTRACT

Provided is a unidirectional shock absorber without losing a damping force reducing effect even with continuous input of high-frequency vibrations. A shock absorber includes: a piston partitioning a cylinder into an extension chamber and a compression chamber; a pressure chamber; a free piston slidably inserted into the pressure chamber; a spring element; an extension chamber-side passage; a compression chamber-side passage; a valve provided to the extension chamber-side passage and configured to offer resistance to a flow from a side closer to the extension chamber to a side closer to the compression chamber; and a check valve provided in parallel with the valve, allowing only a flow from the side closer to the compression chamber to the side closer to the extension chamber, wherein the shock absorber generates a damping force only at the time of elongation.

### TECHNICAL FIELD

The present invention relates to a shock absorber.

### BACKGROUND ART

A shock absorber in the related art is interposed between a vehicle body and an axle of a vehicle and is used to suppress vibrations of the vehicle body. For example, JP 2008-215459 A discloses a shock absorber, including: a cylinder; a piston rod inserted into the cylinder; a piston slidably inserted into the cylinder and mounted on an outer periphery of the piston rod; an extension chamber provided close to the piston rod and a compression chamber provided close to the piston rod, both of which are formed inside the cylinder and partitioned by the piston; a first passage provided to the piston, communicating the extension chamber and the compression chamber; a second passage opened from a leading end to a side portion of the piston rod, communicating the extension chamber and the compression chamber; a pressure chamber connected in the middle of the second passage; a free piston slidably inserted into the pressure chamber; partitioning the pressure chamber into a pressure chamber in the side of extension and a pressure chamber in the side of compression; and a coil spring configured to bias the free piston. The pressure chamber in the side of extension herein is communicated with the extension chamber through the second passage. Similarly, the pressure chamber in the side of compression is communicated with the compression chamber through the second passage.

In the shock absorber configured as described above, the pressure chamber is partitioned by the free piston into the pressure chamber in the side of extension and the pressure chamber in the side of compression, and the extension chamber and the compression chamber are not directly communicated with each other through the second passage. However, motion of the free piston causes changes in capacity ratio of the pressure chamber in the side of extension and the pressure chamber in the side of compression, and causes liquid in the pressure chamber to come in and out of the extension chamber and the compression chamber in accordance with a quantity of motion of the free piston. Therefore, the extension chamber and the compression chamber are apparently communicated with each other through the second passage. In such a shock absorber, a proportion of a flow rate passing through the second passage to a flow rate passing through the first passage is small with respect to input of low-frequency vibrations, and the proportion of the flow rate passing through the second passage to the flow rate passing through the first passage increases with respect to input of high-frequency vibrations.

Therefore, the shock absorber generates a large damping force with respect to the input of low-frequency vibrations. With respect to the input of high-frequency vibrations, the shock absorber exerts a damping force reducing effect so as to generate a small damping force. Accordingly, in a case where frequency of vibrations to be input is low such as a case where a vehicle is turning, it is required that the shock absorber reliably generates a high damping force. Furthermore, in a case where frequency of vibrations to be input is high such as a case where a vehicle is driven along an uneven road, a low damping force to the shock absorber

### SUMMARY OF THE INVENTION

In a case where a shock absorber is mounted on a large-sized vehicle, for example, the shock absorber may be configured to generate a damping force only at the time of elongation so that the shock absorber becomes unidirectional. In such a unidirectional shock absorber that generates a damping force only in the side of extension, a pressure of an extension chamber compressed at the time of elongation is significantly higher than a pressure of a compression chamber compressed at the time of contraction. The pressure of the extension chamber is propagated to a pressure chamber in the side of extension, and the pressure of the compression chamber is propagated to a pressure chamber in the side of compression. Accordingly, repetition of elongation and contraction of the shock absorber at a high frequency increases the pressure of the pressure chamber in the side of extension more than the pressure of the pressure chamber in the side of compression, which displaces a free piston to be biased toward the pressure chamber in the side of compression.

Such biased displacement of the free piston causes small allowance in stroke of the free piston toward the pressure chamber in the side of compression so that the free piston may be brought into contact with a housing and may not be displaced toward the pressure chamber in the side of compression. In a shock absorber disclosed in JP 2008-215459 A, when a free piston reaches an end of stroke, the free piston is suddenly prevented from displacing, which leads to abrupt changes in damping characteristics. In order to avoid such situation, JP 2008-215459 A shows ingenuity in that an area of a passage communicating a compression chamber and a pressure chamber in the side of compression is gradually decreased with an increase in quantity of the stroke from a neutral position of the free piston so as to make it difficult to displace the free piston. Accordingly, in this shock absorber, biased displacement of the free piston causes a constant decrease in the area of the passage so that the free piston should displace under difficult conditions.

In other words, when the shock absorber in the related art is configured to be unidirectional in such a state, continuous input of high-frequency vibrations may vary displacement of the free piston, which leads to a condition that the free piston may be difficult to displace or may reach the end of stroke. Accordingly, a damping force reducing effect may not be sufficiently generated.

An object of the present invention is to solve the aforementioned problems and to provide a unidirectional shock absorber without losing a damping force reducing effect even with continuous input of high-frequency vibrations.

In order to achieve the above object, the shock absorber according to the means for solving the problems in the present invention includes: an extension chamber and a compression chamber partitioned by a piston; pressure chamber; a free piston slidably inserted into the pressure chamber, partitioning the pressure chamber into a pressure chamber in the side of extension and a pressure chamber in the side of compression; a spring element configured to generate a biasing force to suppress displacement of the free piston with respect to the pressure chamber; an extension chamber-side passage configured to communicate the pressure chamber in the side of extension with the extension chamber; a compression chamber-side passage configured to communicate the pressure chamber in the side of compression with the compression chamber; a valve provided to the extension chamber-side passage or the compression chamber-side passage and configured to offer resistance to a flow from a side closer to the extension chamber to a side closer to the compression chamber; and a check valve provided in parallel with the valve, allowing only a flow from the side closer to the compression chamber to the side closer to the extension chamber, wherein the shock absorber generates a damping force only at the time of elongation.

### BRIEF DESCRIPTION OF DRAWINGS

FIG. 1 is a longitudinal sectional view conceptually illustrating a shock absorber according to an embodiment of the present invention.

FIG. 2 is a longitudinal sectional view specifically illustrating a part of the shock absorber according to an embodiment of the present invention.

FIG. 3 is a Bode diagram illustrating gain characteristics of a frequency transfer function of a pressure with respect to a flow rate of the shock absorber according to an embodiment of the present invention.

FIG. 4 is a view illustrating damping characteristics with respect to a frequency of the shock absorber according to an embodiment of the present invention.

### DESCRIPTION OF EMBODIMENTS

Hereinafter, an embodiment of the present invention will be described with reference to the drawings. The same reference numerals in the drawings represent the same parts.

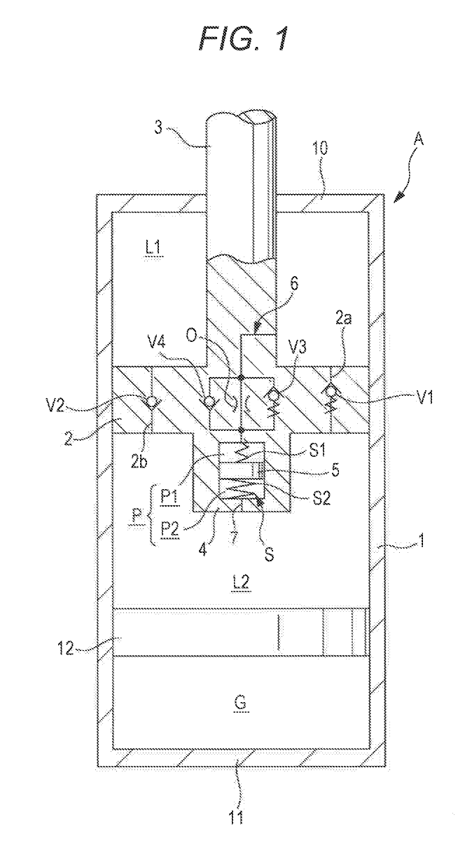

As illustrated in FIG. 1, a shock absorber A according to an embodiment of the present invention is interposed between, for example, a vehicle body and an axle of a large-sized vehicle and configured to generate a damping force to suppress vibrations of the vehicle body. More specifically, the shock absorber A includes a cylinder 1 having a cylindrical shape; a piston 2 slidably inserted into the cylinder 1; a piston rod 3 having one end coupled to the piston 2 and the other end extending outside the cylinder 1; a sliding partition wall 12 slidably inserted into a side in the cylinder 1 opposite to the piston rod; a head member 10 configured to close one opened end of the cylinder 1, while allowing the insertion of the piston rod 3; and a bottom cap 11 configured to close the other opened end of the cylinder 1.

The piston rod is fixed with an attachment member (not illustrated) at an upper end portion protruding from the cylinder 1 in FIG. 1, and the bottom cap 11 is also fixed with an attachment member (not illustrated). The attachment member fixed to the piston rod 3 is coupled to one of the vehicle body and the axle, and the attachment member fixed to the bottom cap 11 is coupled to the other of the vehicle body and the axle. Therefore, separation of the vehicle body from the axle causes the piston rod 3 to withdraw from the cylinder 1 and the shock absorber A to elongate. Conversely, approach of the vehicle body to the axle causes the piston rod 3 to enter into the cylinder 1 and the shock absorber A to contract.

Inside the cylinder 1, formed are an extension chamber L1 and a compression chamber L2 which are partitioned by the piston 2, and a gas chamber G partitioned by the compression chamber L2 and the sliding partition wall 12. The extension chamber L1 is a room which is compressed when the shock absorber A elongates, and which is formed on the upper side of the piston 2 in FIG. 1 in the shock absorber A. The other compression chamber L2 is a room which is compressed when the shock absorber A contracts, and which is formed on the lower side of the piston 2 in FIG. 1 in the shock absorber A. The extension chamber L1 and the compression chamber L2 are filled with liquid such as hydraulic oil, and the gas chamber G contains gas.

The shock absorber A is a single rod type shock absorber in which the piston rod 3 is inserted only into the extension chamber L1. The shock absorber A offsets, at the gas chamber G, changes in intra-cylinder capacity corresponding to volume of the piston rod 3 coming in and out of the cylinder 1. Specifically, elongation of the shock absorber A increases intra-cylinder capacity corresponding to volume of the piston rod 3 coming out of the cylinder 1, but the sliding partition wall 12 moves upward in FIG. 1 so as to expand the gas chamber G. Therefore, an increase in the intra-cylinder capacity is offset. Conversely, contraction of the shock absorber A decreases intra-cylinder capacity corresponding to volume of the piston rod 3 coming into the cylinder 1, but the sliding partition wall 12 moves downward in FIG. 1 so as to contract the gas chamber G. Therefore, a decrease in the intra-cylinder capacity is offset.

Next, the piston 2 is provided with an extension-side piston passage 2a and a compression-side piston passage 2b that communicate the extension chamber L1 with the compression chamber L2. The extension-side piston passage 2a is provided with a damping valve V1 that offers resistance to a flow of liquid from the extension chamber L1 to the compression chamber L2 through the extension-side piston passage 2a. The compression-side piston passage 2b is provided with a compression check valve V2 that allows only a flow of liquid from the compression chamber L2 to the extension chamber L1 through the compression-side piston passage 2b.

The lower side of the piston 2 in FIG. 1 is coupled to a housing 4 in which a pressure chamber P is formed, and the pressure chamber P is provided with a free piston 5 and a spring element S. The free piston 5 is slidably inserted into the housing 4 and displaces upward and downward in FIG. 1 with respect to the housing 4. The spring element S includes a pair of coil springs S1, S2 arranged on the upper and lower sides in FIG. 1, sandwiching the free piston 5. When the free piston 5 displaces from a predetermined position in the housing 4 (hereinafter simply referred to as “neutral position of the free piston”), the spring element S generates a biasing force to suppress the displacement. The biasing force of this spring element S is proportional to the displacement of the free piston 5. The neutral position of the free piston 5 is a position where the free piston 5 is positioned by the spring element S with respect to the pressure chamber P and is not limited to the center of stroke of the free piston 5.

The pressure chamber P formed in the housing 4 is partitioned by the free piston 5 into a pressure chamber in the side of extension P1 disposed on the upper side in FIG. 1 and a pressure chamber in the side of compression P2 disposed on the lower side in FIG. 1. The pressure chamber in the side of extension P1 is communicated with the extension chamber L1 through the extension chamber-side passage 6. The pressure chamber in the side of compression P2 is communicated with the compression chamber L2 through the compression chamber-side passage 7. In this manner, the extension chamber L1 and the pressure chamber in the side of extension P1 are communicated by the extension chamber-side passage 6, and the compression chamber L2 and the pressure chamber in the side of compression P2 are communicated by the compression chamber-side passage 7. Accordingly, capacity of the pressure chamber in the side of extension P1 and the pressure chamber in the side of compression P2 changes depending on the displacement of the free piston 5 inside the housing 4. Therefore, in the shock absorber A, a passage including the extension chamber-side passage 6, the pressure chamber in the side of extension P1, the pressure chamber in the side of compression P2, and the compression chamber-side passage 7 apparently communicates the extension chamber L1 with the compression chamber L2. Accordingly, the extension chamber L1 and the compression chamber L2 are communicated with each other through the aforementioned apparent passage as well as the extension-side piston passage 2a and the compression-side piston passage 2b.

In the middle of the extension chamber-side passage 6, a valve V3, an orifice O, and a check valve V4 are provided in parallel. The valve V3 offers resistance to a flow of liquid from the extension chamber L1 to the pressure chamber in the side of extension P1. The orifice offers resistance to a flow of liquid moving between the extension chamber L1 and the pressure chamber in the side of extension P1. The check valve V4 allows only a flow of liquid from the pressure chamber in the side of extension P1 to the extension chamber L1.

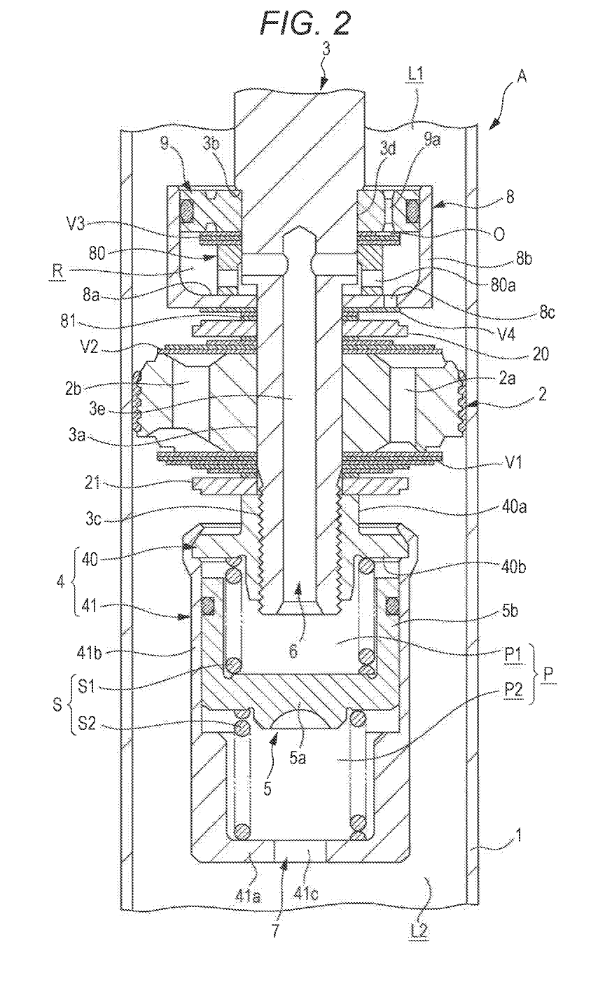

FIG. 2 illustrates an exemplary specific configuration of a part of the piston 2. As illustrated in FIG. 2, the piston 2 and the valves according to the present embodiment are mounted on an outer periphery of a leading end of the piston rod 3. The leading end of the piston rod 3 includes an attachment shaft 3a having an outer diameter smaller than that of other parts. The outer periphery of the piston rod 3 is formed with an annular stepped portion 3b in a boundary between the attachment shaft 3a and other parts. The attachment shaft 3a includes a screw portion 3c at its leading end, and an enlarged diameter portion 3d at its base end. The piston 2 and the valves both have a central hole penetrating their central portion. When the attachment shaft 3a of the piston rod 3 is inserted into these central holes and the housing 4 is screwed into the screw portion 3c, the piston 2 and the valves are fixed as being sandwiched by the housing 4 and the stepped portion 3b. In other words, the housing 4 is also used as a piston nut to mount the piston 2 and the valves on the piston rod 3.

The extension-side piston passage 2a and the compression-side piston passage 2b provided to the piston 2 axially penetrate the piston 2. The damping valve V1 is provided to an outlet of the extension-side piston passage 2a, and the compression check valve V2 is provided to an outlet of the compression-side piston passage 2b. The damping valve V1 is a leaf valve which is laminated on the lower side of the piston 2 in FIG. 2, having an outer periphery allowed to deflect. The damping valve V1 is configured to open and close an end of the outlet of the extension-side piston passage 2a. The damping valve V1 offers resistance to the flow of the liquid from the extension chamber L1 to the compression chamber L2 through the extension-side piston passage 2a. Furthermore, the damping valve V1 allows only the flow of the liquid from the extension chamber L1 to the compression chamber L2 so as to make the extension-side piston passage 2a a one-way passage. The compression check valve V2 is also a leaf valve which is laminated on the upper side of the piston 2 in FIG. 2, having an outer periphery allowed to deflect. The compression check valve V2 is configured to open and close an end of the outlet of the compression-side piston passage 2b. The compression check valve V2 allows only the flow of the liquid from the compression chamber L2 to the extension chamber L1 through the compression-side piston passage 2b so as to make the compression-side piston passage 2b a one-way passage. The damping valve V1 offers resistance to the flow of the liquid passing through the extension-side piston passage 2a so that the number of laminated leaf valves is large. On the other hand, the compression check valve V2 suffices to make the compression-side piston passage 2b a one-way passage so that the number of laminated leaf valves is small.

On the upper side of the compression check valve V2 in FIG. 2 and on the lower side of the damping valve V1 in FIG. 2, valve stoppers 20, 21 are laminated respectively. On the lower side of the valve stopper 21 in FIG. 2, the housing 4 is provided. On the upper side of the valve stopper 20 in FIG. 2, there are provided the case 8 and the sub piston 9 forming, inside the extension chamber L1, a room R communicated with an interior of the housing 4.

The housing 4 includes a nut portion 40 and an outer cylinder 41. The nut portion 40 includes a cylindrical screw cylinder 40a screwed with the screw portion 3c of the piston rod 3; and an annular collar 40b provided to an outer periphery of the screw cylinder 40a. The outer cylinder 41 has a bottomed cylindrical shape in which an opening thereof is fastened to an outer periphery of the collar 40b in an integrated manner. A space surrounded by the nut portion 40 and the outer cylinder 41 is the pressure chamber P. This pressure chamber P is partitioned, by the free piston 5 slidably inserted into the housing 4, into the pressure chamber in the side of extension P1 on the upper side in FIG. 2 and the pressure chamber in the side of compression P2 on the lower side in FIG. 2. The pair of coil springs S1, S2 serving as the spring element S to bias the free piston 5 is contained in the housing 4.

The pressure chamber in the side of extension P1 is communicated with the extension chamber L1 through the room R and a through hole 3e formed along a side portion of the piston rod 3 from the leading end thereof. The pressure chamber in the side of compression P2 is communicated with the compression chamber L2 through a hole 41c axially penetrating a bottom portion 41a of the outer cylinder 41. In other words, in the present embodiment, the extension chamber-side passage 6 communicating the extension chamber L1 and the pressure chamber in the side of extension P1 is configured to include the through hole 3e and the room R, and the compression chamber-side passage 7 communicating the compression chamber L2 and the pressure chamber in the side of compression P2 is configured to include the hole 41c. The extension chamber-side passage 6 will be described later in more detail. The hole 41c is designed not to constrict a flow of liquid moving between the compression chamber L2 and the pressure chamber in the side of compression P2.

In a case where an outer periphery of the housing 4 is provided with a portion having width across flats or in a case where the hole 41c has a hexagonal cross-sectional shape, hooking a tool on the portion having width across flats or the hole 41c prevents corotation of the housing 4 and the tool. Such a manner is convenient when rotating the housing 4 by the tool so as to screw the screw portion 3c of the piston rod 3 into the screw cylinder 40a of the housing 4, and to screw the housing 4 with the piston rod 3.

The free piston 5 inserted into the housing 4 has a bottomed cylindrical shape, including a bottom portion 5a directed downward in FIG. 2, and a cylindrical portion 5b erected upward in FIG. 2 from an outer periphery of the bottom portion 5a. The cylindrical portion 5b is slidably brought into contact with an inner periphery of a cylindrical portion 41b of the outer cylinder 41. An inner diameter of the cylindrical portion 5b of the free piston 5 is larger than an outer diameter of the screw cylinder 40a protruding downward in FIG. 2 from the collar 40b. An axial length of the cylindrical portion 5b is longer than the sum of an axial length of the screw cylinder 40a protruding downward in FIG. 2 from the collar 40b and an axial length of the screw portion 3c protruding downward in FIG. 2 from the screw cylinder 40a. Therefore, even when the free piston 5 moves upward in FIG. 2 and a leading end of the cylindrical portion 5b comes into contact with the collar 40b, the free piston 5 does not interfere with the screw cylinder 40a and the screw portion 3c, and an opening of the through hole 3e in a side closer to the pressure chamber P is not blocked by the bottom portion 5a of the free piston 5.

One coil spring S1 in the pair of coil springs S1, S2 that biases the free piston 5 is interposed between the bottom portion 5a of the free piston 5 and the collar 40b of the housing 4. The other coil spring S2 is interposed between the bottom portion 5a of the free piston 5 and the bottom portion 41a of the housing 4. In this manner, the free piston 5 is supported by being sandwiched between the pair of coil springs S1 and S2. Being positioned at the neutral position in the pressure chamber P, the free piston 5 is elastically supported.

Next, the case 8 forming the room R together with the sub piston 9 inside the extension chamber L1 is formed into a bottomed cylindrical shape, including a bottom portion 8a directed downward in FIG. 2, and a cylindrical portion 8b extending upward in FIG. 2 from an outer periphery of the bottom portion 8a. On the upper side of the bottom portion 8a in FIG. 2, which is to be an interior of the case 8, a spacer 80, the valve V3, and the sub piston 9 are laminated in the order mentioned. On the lower side of the bottom portion 8a in FIG. 2, which is to be an exterior of the case 8, the check valve V4 and a distance piece 81 are laminated in the order mentioned. An outer diameter of the sub piston 9 is larger than that of the spacer 80 so that an annular gap is formed between the spacer 80 and the cylindrical portion 8b of the case 8, and an opening of the case 8 is covered by the sub piston 9. A space surrounded by the case 8 and the sub piston 9, and formed on an outer periphery of the spacer 80 is the room R.

The spacer 80 surrounds one end of the through hole 3e opened at the side portion of the piston rod 3. A part of an inner diameter of the spacer 80 that faces the opened end of the through hole 3e is enlarged so as to form a gap between the spacer 80 and the piston rod 3 in a circumferential direction. Furthermore, the spacer 80 is formed with a hole 80a radially penetrating the spacer 80 and communicating the gap with the room R. Therefore, even when the opened end of the through hole 3e and the hole 80a are shifted in the circumferential direction, the through hole 3e and the room R are constantly communicated with each other through the gap and the hole 80a. Accordingly, it is not required to align the piston rod 3 and the spacer 80 in the circumferential direction, which facilitates assembly of the shock absorber A.

The sub piston 9 is provided with an extension port 9a axially penetrating the sub piston 9. Furthermore, the bottom portion 8a of the case 8 is provided with a compression port 8c axially penetrating the bottom portion 8a. The extension chamber L1 and the room R are communicated with each other through the extension port 9a and the compression port 8c. The other end of the through hole 3e in which one end is communicated with the room R through the hole 80a, as described above, is opened toward the pressure chamber in the side of extension P1. Therefore, the pressure chamber in the side of extension P1 and the extension chamber L1 are communicated with each other, involving the through hole 3e, hole 80a, room R, extension port 9a, and compression port 8c. In other words, in the shock absorber A, the extension chamber-side passage 6 that communicates the extension chamber L1 and the pressure chamber in the side of extension P1 is configured to include the through hole 3e, hole 80a, room R, extension port 9a, and compression port 8c. The extension chamber-side passage 6 is bifurcated from the room R in the middle of the extension chamber-side passage 6, and is communicated with the extension chamber L1. One bifurcation portion of the passage divided into two is the extension port 9a, and the other bifurcation portion is the compression port 8c.

Next, the extension port 9a is opened and closed by the valve V3 provided inside the case 8. This valve V3 is a leaf valve in which an inner periphery is sandwiched and fixed by the sub piston 9 and the spacer 80, having an outer periphery allowed to deflect. The valve V3 is configured to open and close an end of an outlet of the extension port 9a. The valve V3 offers resistance to the flow of the liquid from the extension chamber L1 to the pressure chamber in the side of extension P1 through the extension port 9a. Furthermore, the valve V3 allows only the flow of the liquid from the extension chamber L1 to the pressure chamber in the side of extension P1 so as to make the extension port 9a a one-way passage. Still further, a first leaf valve included in the valve V3 is a notched leaf valve having a notch. Therefore, even when the valve V3 closes the extension port 9a, the notch forms an orifice O communicating the extension chamber L1 with the room R. The orifice O not only allows a bidirectional flow into the extension chamber L1 and the room R but also offers resistance to the flow.

The compression port 8c is opened and closed by the check valve V4 provided outside the case 8. This check valve V4 is also a leaf valve in which an inner periphery is sandwiched and fixed by the distance piece 81 and the bottom portion 8a of the case 8, having an outer periphery allowed to deflect. The check valve V4 is configured to open and close an end of an outlet of the compression port 8c. The check valve V4 allows only a flow from the room R to the extension chamber L1 through the compression port 8c so as to make the compression port 8c a one-way passage.

Hereinafter, operations of the shock absorber A of the present embodiment will be described.

When the shock absorber A elongates, the piston 2 moves upward in FIG. 2 relative to the cylinder 1 to compress the extension chamber L1 and to expand the compression chamber L2. Then, the liquid in the extension chamber L1 opens the damping valve V1 and passes through the extension-side piston passage 2a so as to move to the compression chamber L2. In this manner, the damping valve V1 offers resistance to the flow of the liquid passing from the extension chamber L1 to the compression chamber L2 through the extension-side piston passage 2a so that a pressure of the extension chamber L1 becomes higher than a pressure of the compression chamber L2. Therefore, a differential pressure is generated between the pressure of the extension chamber L1 and the pressure of the compression chamber L2. This differential pressure acts on the piston 2 so that the shock absorber A exerts a damping force to hinder elongation.

An increase in the pressure in the extension chamber L1 causes the liquid in the extension chamber L1 to pass through the extension passage 6 from the extension port 9a, room R, hole 80a, and through hole 3e in the order mentioned so as to flow into the pressure chamber in the side of extension P1. In the shock absorber A, the liquid in the extension chamber L1 flows into the room R through the orifice O until reaching a pressure at which the valve V3 opens. After the valve V3 opens, the liquid in the extension chamber L1 passes between an outer peripheral part of the valve V3 and the sub piston 9 so as to flow into the room R. In this manner, when the liquid in the extension chamber L1 flows into the pressure chamber in the side of extension P1 through the extension chamber-side passage 6, the free piston 5 moves downward in FIG. 2 in the housing 4, which expands the capacity of the pressure chamber in the side of extension P1. Accordingly, the capacity of the pressure chamber in the side of compression P2 is contracted, and the liquid in the pressure chamber in the side of compression P2 is pushed out to the compression chamber L2 through a hole 42c or the compression chamber-side passage 7. In other words, when the shock absorber A elongates, the liquid moves from the extension chamber L1 to the compression chamber L2 through the apparent passage including the extension chamber-side passage 6, the pressure chamber in the side of extension P1, the pressure chamber in the side of compression P2, and the compression chamber-side passage 7 as well as the extension-side piston passage 2a.

Herein, whether frequency of vibrations input to the shock absorber A, that is, frequency of elongation and contraction of the shock absorber A is low or high, when a piston speed in elongating the shock absorber A is equivalent, amplitude of the shock absorber A at the time of inputting low-frequency vibrations becomes larger than amplitude of the shock absorber A at the time of inputting high-frequency vibrations. In this manner, low-frequency vibrations input to the shock absorber A leads to large amplitude, which increases a flow rate of the liquid from the extension chamber L1 to the compression chamber L2. Then, displacement of the free piston 5 increases substantially proportional to this flow rate, which also increases the biasing force the free piston 5 receives from the spring element S. Accordingly, a differential pressure is generated between a pressure of the pressure chamber in the side of extension P1 and a pressure of the pressure chamber in the side of compression P2, which decreases a differential pressure between the extension chamber L1 and the pressure chamber in the side of extension P1 and a differential pressure between the compression chamber L2 and the pressure chamber in the side of compression P2. Therefore, a flow rate passing through the apparent passage decreases. Such a decrease in flow rate passing through the apparent passage leads to an increase in flow rate of the extension-side piston passage 2a so that the damping force generated by the shock absorber A is maintained to be large.

In a case where high-frequency vibrations are input to the shock absorber A, amplitude is smaller than the amplitude at the time of inputting low-frequency vibrations. Therefore, the flow rate of the liquid from the extension chamber L1 to the compression chamber L2 is decreased, which also decreases displacement of the free piston 5. Then, the biasing force the free piston 5 receives from the spring element S is also decreased. Accordingly, the pressure of the pressure chamber in the side of extension P1 and the pressure of the pressure chamber in the side of compression P2 become substantially equivalent. Furthermore, the differential pressure between the extension chamber L1 and the pressure chamber in the side of extension P1 and the differential pressure between the compression chamber L2 and the pressure chamber in the side of compression P2 become larger than those at the time of inputting low-frequency vibrations. Thus, the flow rate passing through the apparent passage increases more than that at the time of inputting low-frequency vibrations. Such an increase in this apparent flow rate leads to a decrease in flow rate of the extension-side piston passage 2a so that the damping force generated by the shock absorber A becomes lower than that at the time of inputting low-frequency vibrations.

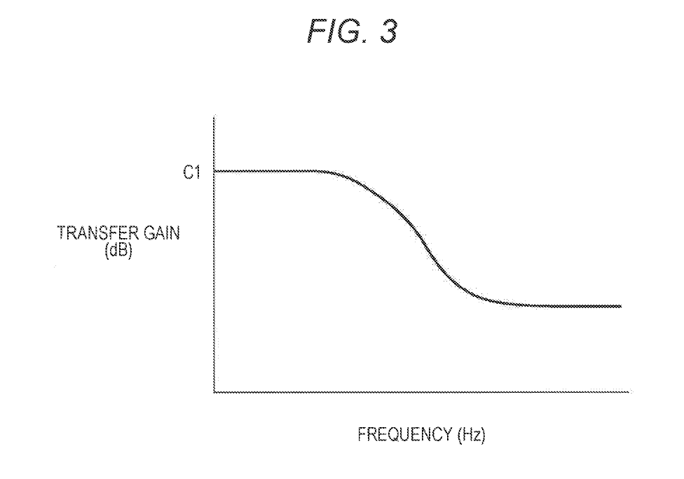

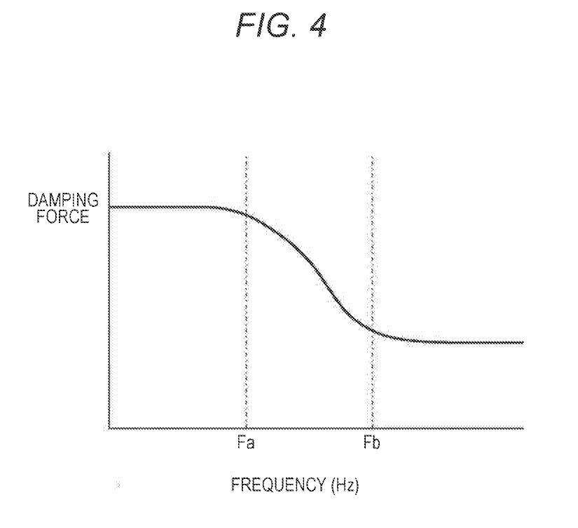

In regard to a frequency transfer function of a differential pressure with respect to a flow rate, gain characteristics with respect to frequency becomes high for low-frequency vibrations and becomes low for high-frequency vibrations as illustrated in FIG. 3. In regard to characteristics of the damping force in the shock absorber A indicating gain of the damping force with respect to input of vibration frequency, a large damping force is generated for vibrations in a low-frequency range, and the damping force can be decreased for vibrations in a high-frequency range as illustrated in FIG. 4. Accordingly, changes in the damping force of the shock absorber A depends on vibration frequency to be input. Herein, a value of break frequency Fa having a small value in the damping characteristics of FIG. 4 is set to be equal to or more than a value of resonance frequency of sprung mass of a vehicle and to be equal to or less than a value of resonance frequency of unsprung mass of the vehicle. Furthermore, a value of break frequency Fb having a large value is set to be equal to or less than the resonance frequency of unsprung mass of the vehicle. In such a state, the shock absorber A is configured to generate a high damping force with respect to input of vibrations of the resonance frequency of sprung mass so that it is possible to stabilize an attitude of the vehicle and to prevent a passenger from feeling uneasy when the vehicle is turning. In addition, the shock absorber A always generates a low damping force whenever vibrations of the resonance frequency of unsprung mass is input so that it is possible to insulate transfer of vibrations in the side of the axle toward the vehicle body, which offers a comfortable ride in the vehicle.

Furthermore, in the shock absorber A, an increase in flow rate of the liquid moving through the apparent passage opens the valve V3. With a high flow rate, a pressure loss due to the valve V3 is smaller than a pressure loss due to the orifice O so that it is possible to move the free piston 5 smoothly and to sufficiently exert a damping force reducing effect at the time of inputting high-frequency vibrations.

Next, when the shock absorber A contracts, the piston 2 moves downward in FIG. 2 relative to the cylinder 1 to compress the compression chamber L2 and to expand the extension chamber L1. Then, the liquid in the compression chamber L2 opens the compression check valve V2 and passes through the compression-side piston passage 2b so as to move to the extension chamber L1. In this manner, the liquid passing from the compression chamber L1 to the extension chamber L2 through the compression-side piston passage 2b is allowed to flow by the compression check valve V2 so that the pressure of the extension chamber L1 and the pressure of the compression chamber L2 becomes substantially equivalent. Therefore, according to the shock absorber A, a damping force to hinder compression is not substantially exerted. In other words, the shook absorber A is a unidirectional shock absorber configured to exert a damping force only at the time of elongation.

Assumed that the shock absorber A elongates, and the free piston 5 is displaced downward in FIG. 2 as described above. From such a state, when the shock absorber A is switched to contract, the free piston 5 receives the biasing force from the spring element S and moves upward in FIG. 2. Accordingly, the capacity of the pressure chamber in the side of compression P2 increases, and such an increase causes the liquid in the compression chamber L1 to flow into the pressure chamber in the side of compression P2 through the hole 41c or the compression chamber-side passage 7. At the same time, the capacity of the pressure chamber in the side of extension P1 decreases, and such a decrease pushes the liquid in the pressure chamber in the side of extension P1 out to the extension chamber L1 through the extension chamber-side passage 6 from the through hole 3e, hole 80a, room R, orifice O, and compression port 8c in the order mentioned. In this manner, when the shook absorber A contracts, the check valve V4 opens and the liquid passes through the compression port 8c so that the liquid in the pressure chamber in the side of extension P1 is promptly discharged no the extension chamber L1. Therefore, when the shock absorber A contracts, the free piston 5 quickly returns to the neutral position by the biasing force of the spring element S.

Hereinafter, functions and effects of the shock absorber A according to the present embodiment will be described.

In the present embodiment, the damping valve V1, compression check valve V2, valve V3, and check valve V4 are leaf valves. Those leaf valves are thin annular plates and can be mounted on the piston rod 3 with short axial lengths, which prevents the shock absorber A from being bulky in the axial direction and secures a stroke length of the shock absorber A. Note that it is possible to appropriately modify types as well as the number of laminated leaf valves included in the extension valve V1, compression check valve V2, valve V3, and check valve V4. For example, any one of the above valves may be a poppet valve including a valve body having an umbrella shape and a spring to bias the valve body.

Furthermore, in the present embodiment, the spring element S is configured to include the pair of coil springs S1, S2 provided on both sides of the free piston 5 in a direction of sliding. According to this configuration, the shock absorber A is a bidirectional shock absorber configured to exert a damping force both at the time of elongation and contraction, and to use the same spring element, free piston, and housing which are used in reducing a damping force when inputting high-frequency vibrations. However, the shock absorber A herein is a unidirectional shock absorber that exerts a damping force only in the side of extension. Therefore, the coil spring S1 may be removed from the pressure chamber in the side of extension P1, and the coil spring S2 serving as the spring element S may be provided only to the pressure chamber in the side of compression P2. In this case, it is possible to reduce the number of components included in the shock absorber A and to reduce the number of steps in assembly. In a case where the spring element S is provided only to the pressure chamber in the side of compression P2, it is preferable to provide a damper member such as rubber on one of the cylindrical portion 5b of the free piston 5 and the collar 40b so as to prevent abnormal noise when the free piston 5 comes into contact with the collar 40b. Furthermore, in the shock absorber A, the spring element S is the coil springs S1, S1, but the spring element S may be springs other than the coil springs or may be elastomers such as rubber.

In the present embodiment, the piston 2 is provided with the extension-side piston passage 2a and the compression-side piston passage 2b communicating the extension chamber L1 with the compression chamber L2. The piston 2 is also mounted with the damping valve V1 configured to offer resistance to the flow from the extension chamber L1 to the compression chamber L2 through the extension-side piston passage 2a, and the compression check valve V2 configured to allow only the flow from the compression chamber L2 to the extension chamber L1 through the compression-side piston passage 2b. According to this configuration, when the shock absorber A elongates, a differential pressure is generated between the pressure of the extension chamber L1 and that of the compression chamber L2 so as to exert a damping force to suppress extension. However, when the shock absorber A contracts, the pressures of the extension chamber L1 and that of the compression chamber L2 are substantially equivalent so that the shock absorber A does not exhibit a damping force and is unidirectional.

However, it is possible to appropriately change the configuration to make the shock absorber A unidirectional. For example, as long as the compression check valve V2 is provided to the compression-side piston passage 2a, the damping valve V1 of the extension-side piston passage 2a may be changed from the leaf valve to an orifice or a choke to throttle the extension-side piston passage 2a so that the bidirectional flow of the extension-side piston passage 2a is allowed. Furthermore, the extension-side piston passage 2a and the compression-side piston passage 2b provided to the piston 2 may be removed, and the damping valve V1 and the compression check valve V2 may be provided in the middle of a passage provided outside the cylinder 1, communicating the extension chamber L1 and the compression chamber L2. Such a modification can be implemented regardless of types of the extension valve V1, compression check valve V2, valve V3, and check valve V4 as well as types and arrangement of the spring element S.

In the present embodiment, the shock absorber A includes the casing 8; the sub piston 9 forming, inside the case 8, the room R communicated with the pressure chamber P; the extension port 9a provided to the sub piston 9, communicating the room R and the extension chamber L1; and the compression port 8c provided to the case 8, communicating the room R and the extension chamber L1. The extension chamber-side passage 6 is configured to have the room R, extension port 9a, and compression port 8c. The valve V3 is laminated on the sub piston 9 and is configured to open and close the extension port 9a. The check valve V4 is laminated on the case 8 and is configured to open and close the compression port 5c. According to the above configuration, it is easy to provide the valve V3 and the check valve V4 in parallel.

Furthermore, in the shock absorber A, the valve V3 and the check valve V4 are arranged inside the extension chamber L1 in the upper side of the piston 2 in FIG. 2. Accordingly, when the valve V3 and the check valve V4 are leaf valves, it is possible to increase outer diameters of those valves and to increase diameters of valve seats (not illustrated) which those valves are separated from or attached to. Thus, the check valve V4 easily deflects, which improves latitude of resistance offered to the flow of the liquid passing through the valve V3. however, arrangement of the valve V3 and the check valve V4 can be appropriately modified. Such a modification can be implemented regardless of types and arrangement of the spring element S as well as types of the damping valve V1, compression check valve V2, valve V3, and check valve V4.

In the present embodiment, the shock absorber A includes: the cylinder 1; the piston 2 slidably inserted into the cylinder 1, partitioning the cylinder 1 into the extension chamber L1 and the compression chamber L2; the damping valve V1 configured to offer resistance to a flow from the extension chamber L1 to the compression chamber L2; the pressure chamber P; the free piston 5 slidably inserted into the pressure chamber P, partitioning the pressure chamber P into the pressure chamber in the side of extension P1 and the pressure chamber in the side of compression P2; the soring element S configured to generate a biasing force to suppress displacement of the free piston 5 with respect to the pressure chamber P; the extension chamber-side passage 6 configured to communicate the pressure chamber in the side of extension P1 with extension chamber L1; the compression chamber-side passage 7 configured to communicate the pressure chamber in the side of compression P2 with the compression chamber L2; the valve V3 provided to the extension chamber-side passage 6 and configured to offer resistance to a flow from the extension chamber L1 (a side closer to the extension chamber L1) to the pressure chamber in the side of extension P1 (a side closer to the compression chamber L2); and the check valve V4 provided in parallel with the valve V3, allowing only a flow from the pressure chamber in the side of extension P1 (the side closer to the compression chamber L2) to the extension chamber L1 (the side closer to the extension chamber L1), wherein the shock absorber A generates a damping force only at the time of elongation.

According to the above configuration, when the shock absorber A elongates, the liquid in the extension chamber L1 flows into the pressure chamber in the side of extension P1 through the valve V3. When a flow rate of liquid flowing into the pressure chamber in the side of extension P1 is high, the pressure loss due to the valve is smaller than the pressure loss due to the orifice O so that it is possible to move the free piston 5 smoothly and to sufficiently exert a pressure reducing effect at the time of inputting high-frequency vibrations. Assumed that the shock absorber A elongates, and the pressure of the extension chamber L1 is propagated to the pressure chamber in the side of extension P1 through the extension chamber-side passage 6, and the free piston 5 is displaced downward in FIG. 2. From such a state, when the shock absorber A is switched to contract, the liquid in the pressure chamber in the side of extension L1 opens the check valve V4 and promptly escapes to the extension chamber L1. Accordingly, even when the shock absorber A is unidirectional, the free piston 5 promptly returns to the neutral position at the time of contraction so that it is possible to prevent the free piston 5 from being biased, which protects the damping force reducing effect.

In the shock absorber A, the valve V3 is provided to the extension chamber-side passage 6, and allows only the flow from the extension chamber L1 to the pressure chamber in the side of extension P1, considering the extension chamber L1 as the extension chamber L1 and the pressure chamber in the side of extension P1 as the compression chamber L2. However, note that the valve V3 may be an orifice or a choke which allows a bidirectional flow of the extension chamber-side passage 6 and offers resistance to the bidirectional flow. Furthermore, the valve V3 may be provided to the compression chamber-side passage 7 and may offer resistance to a flow of liquid passing through the compression chamber-side passage 7. In this manner, when the valve V3 is provided to the compression chamber-side passage 7, the check valve V4 arranged in parallel with the valve V3 is set to allow a flow from the compression chamber L2 to the pressure chamber in the side of compression P2, considering the compression chamber L2 as the compression chamber L2 and the pressure chamber in the side of compression P2 as the extension chamber L1.

Although the shock absorber A is of a single rod type, the piston rod 3 may be inserted into both the extension chamber L1 and the compression chamber L2 so as to form a double rod type shock absorber.

The shock absorber A is a single-cylinder configured to offset, at the gas chamber G, changes in intra-cylinder capacity corresponding to volume of the piston rod 3 coming in and out of the cylinder 1 and changes in volume of liquid due to temperature changes. However, the cylinder 1 may be provided with an outer cylinder in its outer periphery so as to be multi-cylinder. In this case, a reservoir containing liquid and gas may be provided between the cylinder 1 and the outer cylinder, and changes in intra-cylinder capacity and changes in volume of liquid may be offset by the reservoir.

Such modifications described above can be implemented regardless of types and arrangement of the damping valve V1, compression check valve V2, valve V3, and check valve V4.

This application claims priority based on Japanese Patent Application No. 2015-145421 filed in Japan Patent Office on Jul. 23, 2015, the contents of which are incorporated herein by reference in its entirety.

1. A shock absorber comprising:
a cylinder;
a piston slidably inserted into the cylinder, partitioning the cylinder into an extension chamber and a compression chamber;
a damping valve configured to offer resistance to a flow from the extension chamber to the compression chamber;
a pressure chamber;
a free piston slidably inserted into the pressure chamber, partitioning the pressure chamber into a pressure chamber in the side of extension and a pressure chamber in the side of compression;
a spring element configured to generate a biasing force to suppress displacement of the free piston with respect to the pressure chamber;
an extension chamber-side passage configured to communicate the pressure chamber in the side of extension with the extension chamber;
a compression chamber-side passage configured to communicate the pressure chamber in the side of compression with the compression chamber;
a valve provided to the extension chamber-side passage or the compression chamber-side passage and configured to offer resistance to a flow from a side closer to the extension chamber to a side closer to the compression chamber; and
a check valve provided in parallel with the valve, allowing only a flow from the side closer to the compression chamber to the side closer to the extension chamber,
wherein the shock absorber generates a damping force only at the time of elongation.

2. A The shock absorber according to claim 1, comprising:
a case;
a sub piston forming, inside the case, a room communicated with the pressure chamber;
an extension port provided to the sub piston, communicating the room with the extension chamber; and
a compression port provided to the case, communicating the room with the extension chamber,
wherein the extension chamber-side passage includes the room, the extension port, and the compression port,
the valve is laminated on the sub piston and configured to open and close the extension port, and
the check valve is laminated on the case and configured to open and close the compression port.

3. A The shock absorber according to claim 1,
wherein the piston is provided with an extension-side piston passage and a compression-side piston passage communicating the extension chamber with the compression chamber, and
the piston is mounted with the damping valve configured to offer resistance to the flow from the extension chamber to the compression chamber through the extension-side piston passage, and a compression check valve configured to allow only a flow from the compression chamber to the extension chamber through the compression-side piston passage.

4. A The shock absorber according to claim 1, wherein the spring element is provided only to the pressure chamber in the side of compression.
